(19) United States
(12) Patent Application Publication
(10) Pub. No.: US 2025/0145438 A1
(43) Pub. Date: May 8, 2025

(54) JACK FOOT PAD

(71) Applicant: Stromberg-Carlson Products, Inc., Traverse City, MI (US)

(72) Inventor: Robert Brammer, JR., Traverse City, MI (US)

(21) Appl. No.: 18/504,513

(22) Filed: Nov. 8, 2023

(51) Int. Cl. B66F 13/00

(52) U.S. Cl. CPC B66F 13/00

(57) ABSTRACT

A vertically adjustable jack for supporting a movable body on a surface, with the jack having a jack foot including a bottom plate and vertically extending walls extending upwardly from the bottom plate. A foot pad is releasably secured to the jack foot, with the foot pad being formed of a resilient and flexible material. The foot pad includes a pair of opposite facing receptacles, with opposite ends of the jack foot being received within each of the pair of opposite facing receptacles. The foot pad includes top ledges extending over each of the pair of opposite facing receptacles. The resilient and flexible material of the foot pad is configured to be deflected to allow the opposite ends of the jack foot to be positioned within the pair of opposite facing receptacles and the pair of opposite facing receptacles then resiliently returning to an original shape of the foot pad.

### FIELD OF THE INVENTION

The present invention relates to jacks, and in particular to a foot pad for a jack.

### BACKGROUND OF THE INVENTION

Recreational vehicles typically employ jacks to support the recreational vehicles when the vehicles are parked. The jacks are used to level the recreational vehicles.

It is desirable to devise a more efficient jack system.

### SUMMARY OF THE INVENTION

The present invention, according to one aspect, is directed to a recreational vehicle comprising a movable body having at least one wheel for moving the recreational vehicle, a vertically adjustable jack supporting the movable body on a surface, with the jack having a jack foot including a bottom plate and a pair of vertically extending walls extending upwardly from the bottom plate, and a foot pad releasably secured to the jack foot of the jack, with the foot pad being formed of a resilient and flexible material. The foot pad includes a pair of opposite facing receptacles, with opposite ends of the jack foot including ends of the bottom plate and ends of the pair of vertically extending walls being received within each of the pair of opposite facing receptacles. The foot pad includes top ledges extending over each of the pair of opposite facing receptacles. The resilient and flexible material of the foot pad is configured to be deflected to allow the opposite ends of the jack foot to be positioned within the pair of opposite facing receptacles and the pair of opposite facing receptacles then resiliently returning to an original shape of the foot pad.

Another aspect of the present invention is to provide a jack assembly for a recreational vehicle, the jack assembly comprising a vertically adjustable jack supporting the movable body on a surface, with the jack having a jack foot including a bottom plate and a pair of vertically extending walls extending upwardly from the bottom plate, and a foot pad releasably secured to the jack foot of the jack, with the foot pad being formed of a resilient and flexible material. The foot pad includes a pair of opposite facing receptacles, with opposite ends of the jack foot including ends of the bottom plate and ends of the pair of vertically extending walls being received within each of the pair of opposite facing receptacles. The foot pad includes top ledges extending over each of the pair of opposite facing receptacles. The resilient and flexible material of the foot pad is configured to be deflected to allow the opposite ends of the jack foot to be positioned within the pair of opposite facing receptacles and the pair of opposite facing receptacles then resiliently returning to an original shape of the foot pad.

Yet another aspect of the present invention is to provide a foot pad configured to be connected to a vertically adjustable jack configured to support the vertically adjustable jack on a surface, with the vertically adjustable jack having a jack foot including a bottom plate and a pair of vertically extending walls extending upwardly from the bottom plate. The foot pad comprises a base and a pair of opposite facing receptacles. Each of the receptacles is defined by the base, one of a pair of C-shaped walls and one of a pair of top ledges of the foot pad, with the one of the pair of top ledges being connected to one of the pair of C-shaped walls. The foot pad is configured to receive opposite ends of the jack foot including ends of the bottom plate and ends of the pair of vertically extending walls within each of the pair of opposite facing receptacles, the resilient and flexible material of the foot pad being configured to be deflected to allow the opposite ends of the jack foot to be positioned within the pair of opposite facing receptacles and the pair of opposite facing receptacles then resiliently returning to an original shape of the foot pad.

According to yet another aspect of the present invention, a method of connecting a foot pad to a vertically adjustable jack supporting a movable body having at least one wheel for moving the recreational vehicle is provided. The method comprises providing a vertically adjustable jack supporting the movable body on a surface, with the jack having a jack foot including a bottom plate and a pair of vertically extending walls extending upwardly from the bottom plate, and releasably securing a foot pad to the jack foot of the jack, the foot pad being formed of a resilient and flexible material, the foot pad including a pair of opposite facing receptacles, opposite ends of the jack foot including ends of the bottom plate and ends of the pair of vertically extending walls being received within each of the pair of opposite facing receptacles, the foot pad including top ledges extending over each of the pair of opposite facing receptacles. The step of releasably securing includes deflecting the resilient and flexible material of the foot pad and inserting the opposite ends of the jack foot within the pair of opposite facing receptacles. The method further includes resiliently returning the pair of opposite facing receptacles to an original shape of the foot pad.

### BRIEF DESCRIPTION OF THE DRAWINGS

One or more embodiments of the present invention are illustrated by way of example and should not be construed as being limited to the specific embodiments depicted in the accompanying drawings, in which like reference numerals indicate similar elements.

FIG. 1 is a perspective view of an example recreational vehicle having a pair of jacks each including an embodiment of a jack foot of the present invention.

FIG. 2 is a side perspective view of a prior art jack.

FIG. 3 is a partial perspective view of a first embodiment of the jack foot of the present invention connected to the prior art jack.

FIG. 4 is a perspective view of the first embodiment of the jack foot of the present invention.

FIG. 5 is a top view of the first embodiment of the jack foot of the present invention.

FIG. 6 is a bottom view of the first embodiment of the jack foot of the present invention.

FIG. 7 is a side view of the first embodiment of the jack foot of the present invention.

FIG. 8 is an end view of the first embodiment of the jack foot of the present invention.

FIG. 9 is a first cross-sectional view of the first embodiment of the jack foot of the present invention taken along line IX-IX of FIG. 5.

FIG. 10 is a second cross-sectional view of the first embodiment of the jack foot of the present invention taken along line X-X of FIG. 5.

FIGS. 11A-11C illustrate a process for connecting the first embodiment of the jack foot of the present invention to the prior art jack.

FIG. 12 illustrates a further connection that can be used for securing the first embodiment of the jack foot of the present invention to the prior art jack.

FIG. 13 is a perspective view of a second embodiment of the jack foot of the present invention.

FIG. 14 is a top view of the second embodiment of the jack foot of the present invention.

FIG. 15 is a side view of the second embodiment of the jack foot of the present invention.

FIG. 16 is an end view of the second embodiment of the jack foot of the present invention.

FIG. 17 is a first perspective view of a filler piece of the present invention.

FIG. 18 is a second perspective view of the filler piece of the present invention.

FIG. 19 is an end view of the filler piece of the present invention.

FIG. 20 illustrates a process for connecting the jack foot of the present invention to the prior art jack employing the filler piece.

FIG. 21 is a top view of a third embodiment of the jack foot of the present invention.

The specific devices and processes illustrated in the attached drawings and described in the following specification are simply exemplary embodiments of the inventive concepts. Hence, specific dimensions and other physical characteristics relating to the embodiments disclosed herein are not to be considered as limiting.

### DETAILED DESCRIPTION

For purposes of description herein, it is to be understood that the invention may assume various alternative orientations, except where expressly specified to the contrary. It is also to be understood that the specific devices and processes illustrated in the attached drawings and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

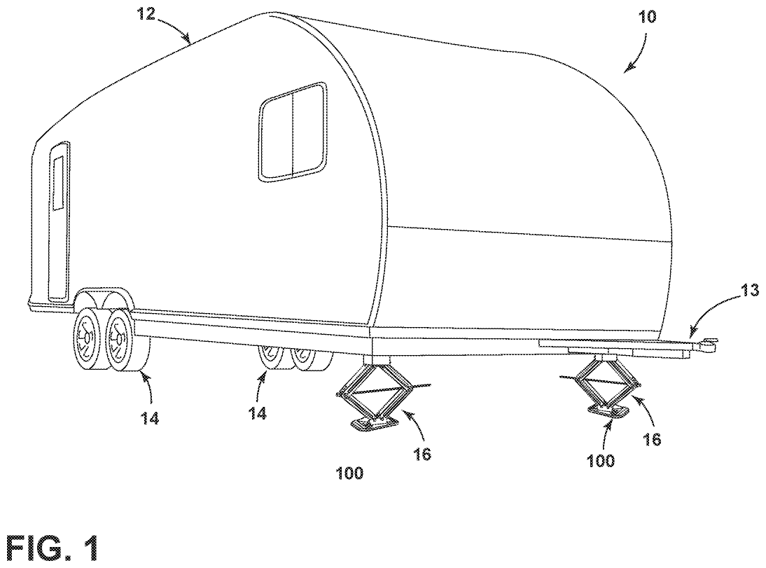

The reference number 10 (FIG. 1) generally designates a recreational vehicle. The recreational vehicle 10 is a motor vehicle or trailer that includes living quarters 12 designed for accommodation. Types of recreational vehicles 10 include motorhomes, campervans, coaches, caravans (also known as travel trailers and camper trailers), fifth-wheel trailers, popup Campers, and truck campers. This list is not exhaustive. The example of the recreational vehicle 10 as shown in FIG. 1 is a motorhome that is pulled behind a vehicle (not shown) by a trailer hitch 13. When the recreational vehicle 10 is stationary for use (e.g., at a trailer park), the living quarters 12 are supported by wheels 14 and a plurality of jacks 16. Although two jacks 16 are shown in FIG. 1, it is contemplated that any number of jacks 16 (including only one) could be used to help support the living quarters 12. Moreover, while the jacks 16 are shown and described herein as supporting a recreational vehicle, the jacks 16 could be used in any manner known to those skilled in the art (e.g., used to lift a vehicle to allow for the tires on the vehicle to be changed). Each of the jacks 16 includes a foot pad 100 of the present invention.

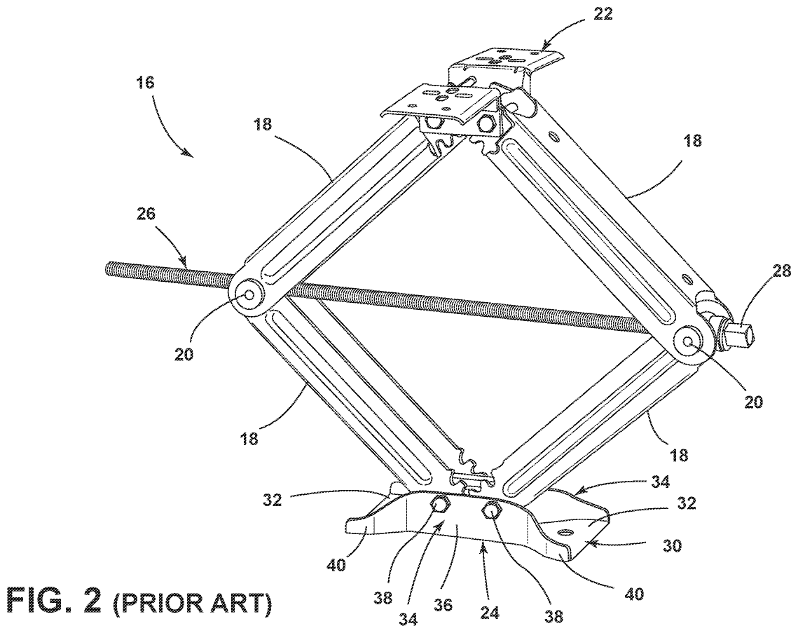

FIG. 2 illustrates an embodiment of the prior art jack 16. Prior art jacks 16 and their use are well known to those skilled in the art. The prior art jack 16 includes four links 18 having ends connected together by two direct pivot pins 20, an upper support plate 22 and a foot 24. As is well known to those skilled in the art, the direct pivot pins 20 move toward and away from each other to raise and lower the upper support plate 22 by rotating a threaded post 26 fixed in position at a first one of the pivot pins 20 through a holder (not shown) at a second one of the pivot pins 20. The threaded post 26 can include a connection head 28 adjacent the first one of the pivot pins 20 for connection to a turner device (e.g., a jack) to rotate the threaded post 26. The foot 24 acts as a support for the entire prior art jack 16 during use thereof. The foot 24 includes an hourglass-shaped bottom plate 30 having wider end areas 32 and a pair of vertically extending curved walls 34 at opposite sides of the hourglass-shaped bottom plate 30. The pair of vertically extending curved walls 34 includes a flat middle area 36 having bolts 38 extending therethrough, with each bolt 38 being pivotally connected to one of the links 18. Each of the pair of vertically extending curved walls 34 includes opposite curved end wall areas 40.

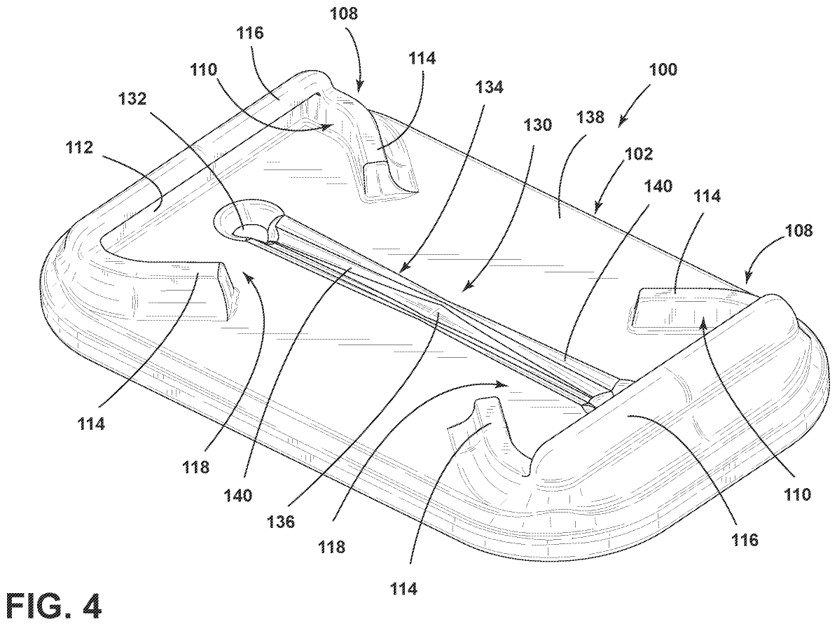

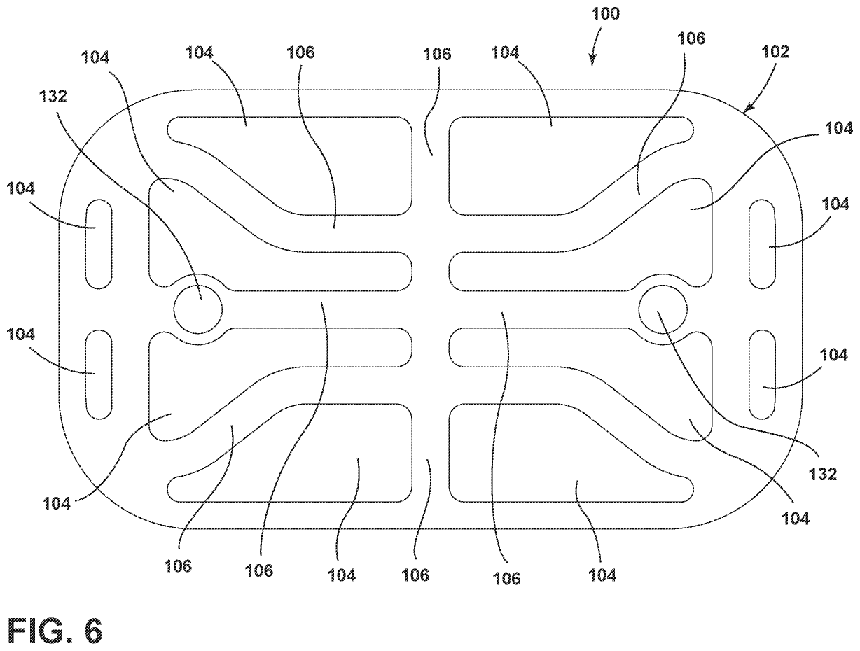

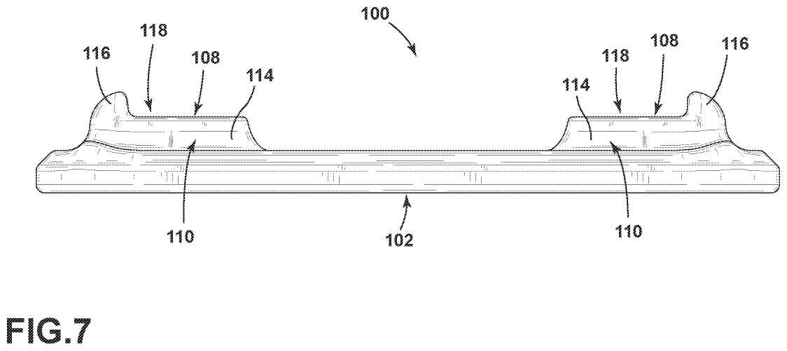

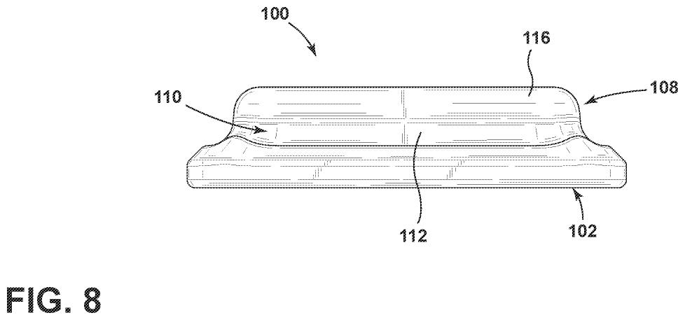

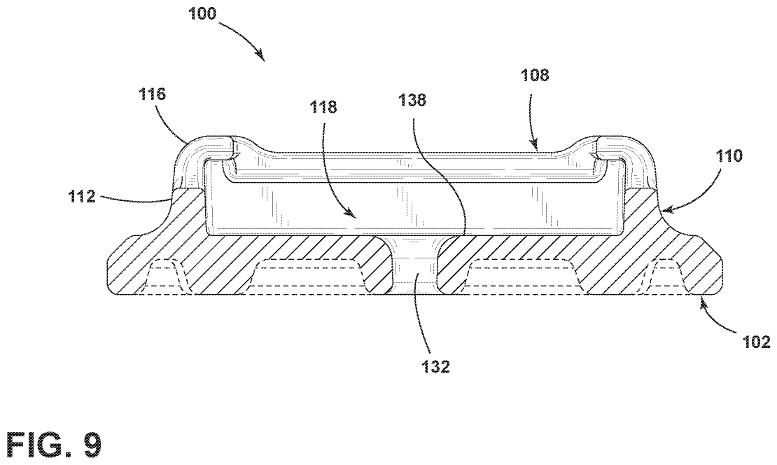

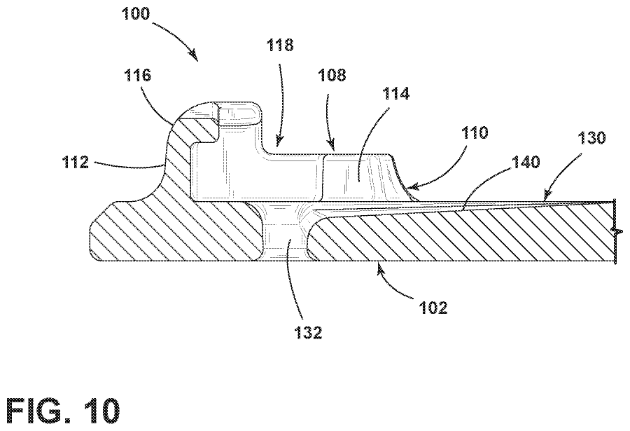

FIGS. 4-10 illustrate a first embodiment of the foot pad 100 configured to be connected to the foot 24 of the prior art jack 16 for supporting the foot 24 on a surface for insulating the foot 24 from elements while adding traction for the foot 24 on the surface (e.g., the ground or a block). The foot pad 100 can be formed from any appropriate resilient and flexible material (e.g., EPDM rubber) and can be molded as a single piece. The foot pad 100 includes a substantially rectangular base 102 (although it is contemplated that the base 102 could have any peripheral shape). The base 102 can be a solid piece with a uniform thickness or can include a plurality of bottom recesses 104 (see FIG. 6) that define a grid of struts 106. The bottom recesses 104 allow for use of less material for forming the foot pad 100 while the grid of struts 106 provide for strength and stability for the foot pad 100.

The illustrated foot pad 100 includes a pair of opposite facing receptacles 108 that each are configured for receiving the wider end areas 32 of the hourglass-shaped bottom plate 30 of the foot 24 of the prior art jack 16. Each of the receptacles includes a C-shaped wall 110 having a straight wall portion 112 and a pair of curved wall portions 114 at each end of the straight wall portion 112. An inner periphery of the C-shaped wall 110 substantially conforms to an outer periphery of the wider end areas 32 of the hourglass-shaped bottom plate 30 of the foot 24 of the prior art jack 16. A top ledge 116 of the opposite facing receptacles 108 extends inwardly from a top edge of the straight wall portion 112 and an end section of the curved wall portions 114. An area under the top ledge 116 and inside of the C-shaped wall 110 defines a foot receptacle area 118 for receiving one side of the foot 24 of the prior art jack 16.

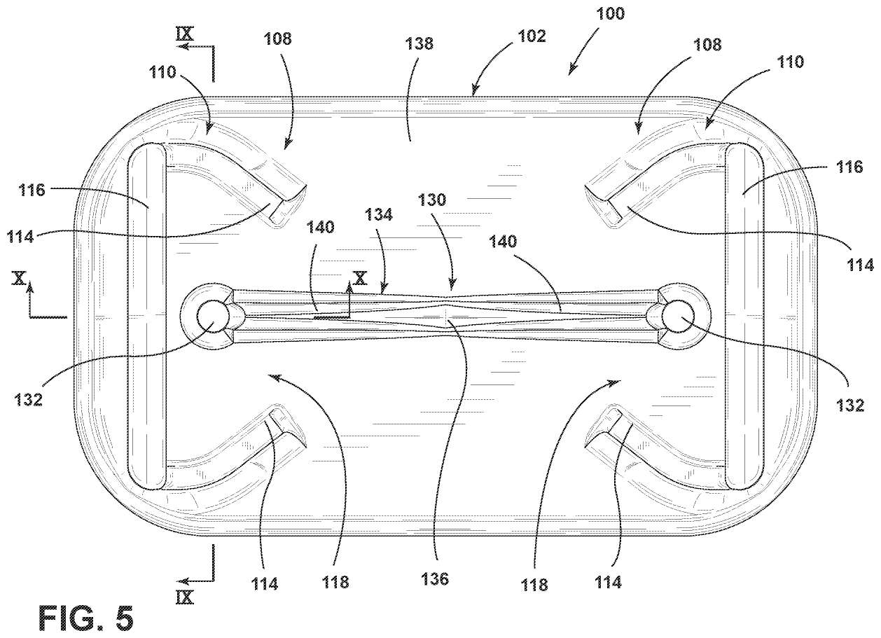

In the illustrated embodiment, the foot pad 100 can include a water drain system 130 for allowing water on the base 102 to drain through the base 102. As shown in FIGS. 4-6, the water drain system 130 includes a plurality of drain holes 132 in the base 102. While two drain holes 132 are shown, any number of drain holes 132 can be employed in the water drain system 130. The water drain system 130 can include at least one drain channel 134 for leading water to the drain holes 132. As shown in FIGS. 4 and 5, an embodiment of the drain channel 134 can include an apex 136 at a level slightly below a top surface 138 of the base 102 and sloped grooves 140 that lead from the apex 136 to each of the drain holes 132. It is contemplated that any number of sloped grooves 140 leading to drain holes could be used or that each of the drain holes 132 can have a drain channel 134 that only leads to a single one of the drain holes 132.

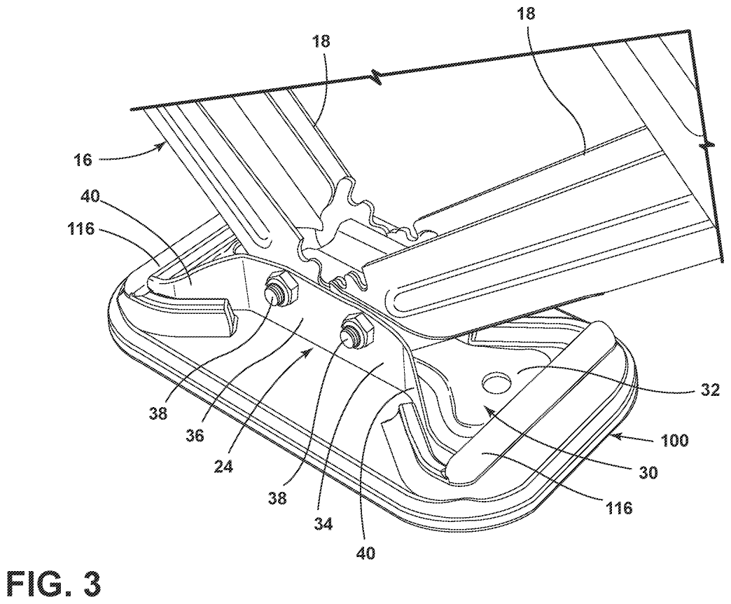

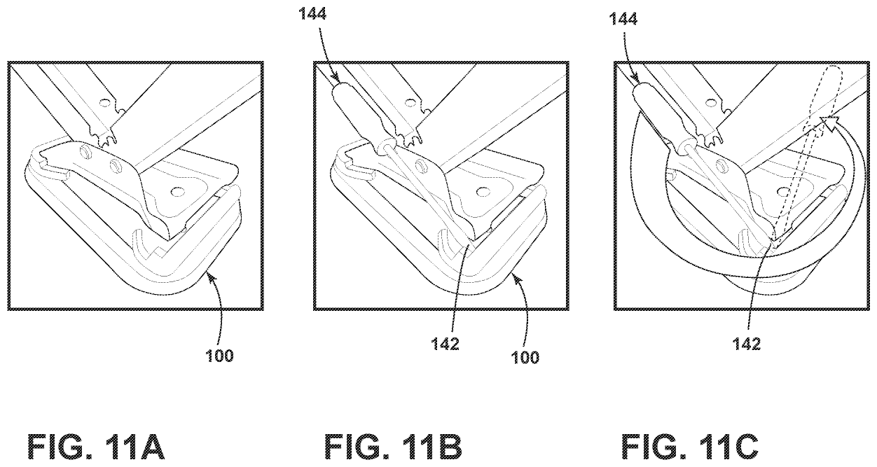

In the illustrated embodiment, the foot pad 100 is connected to the foot 24 of the prior art jack 16 as shown in FIG. 3. FIGS. 11A-11C illustrate a manner of easily inserting the foot 24 of the prior art jack 16 into the foot pad 100. First, as shown in FIG. 11A, a first end of the foot 24 that includes the wider end areas 32 of the hourglass-shaped bottom plate 30 is inserted into the foot receptacle area 118 of a first one of the opposite facing receptacles 108 of the foot pad 100. A second end of the foot 24 is then positioned on or directly adjacent to a top of the top ledge 116 of a second one of the opposite facing receptacles 108 of the foot pad 100. A flat object, such as a flat head 142 of screwdriver 144, is positioned between an outside surface of the curved end wall areas 40 of one of the pair of vertically extending curved walls 34 at the second end of the foot 24 and one of the curved wall portions 114 of the C-shaped wall 110 of the opposite facing receptacles 108 as shown in FIG. 11B. The flat object is then rotated as shown in FIG. 11C to lift the top ledge 116 of the opposite facing receptacles 108 while simultaneously pushing the second end of the foot 24 into the foot receptacle area 118.

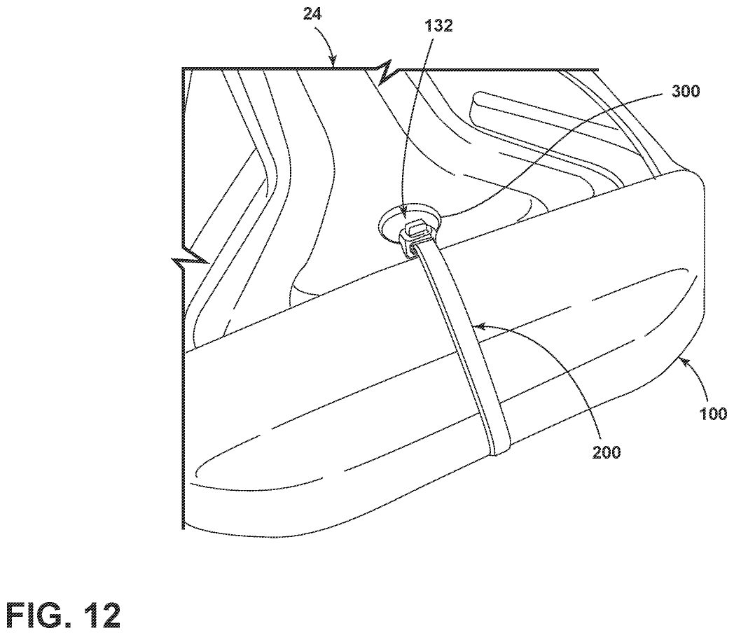

The illustrated foot pad 100 is connected to the foot 24 of the prior art jack 16 to support the foot 24 on a surface and provide traction for the foot 24. As shown in FIG. 12, a zip tie 200 (or similar connector) can be inserted through an opening 300 in the foot 24 and one of the drain holes 132 for fixedly connecting the foot pad 100 to the foot 24.

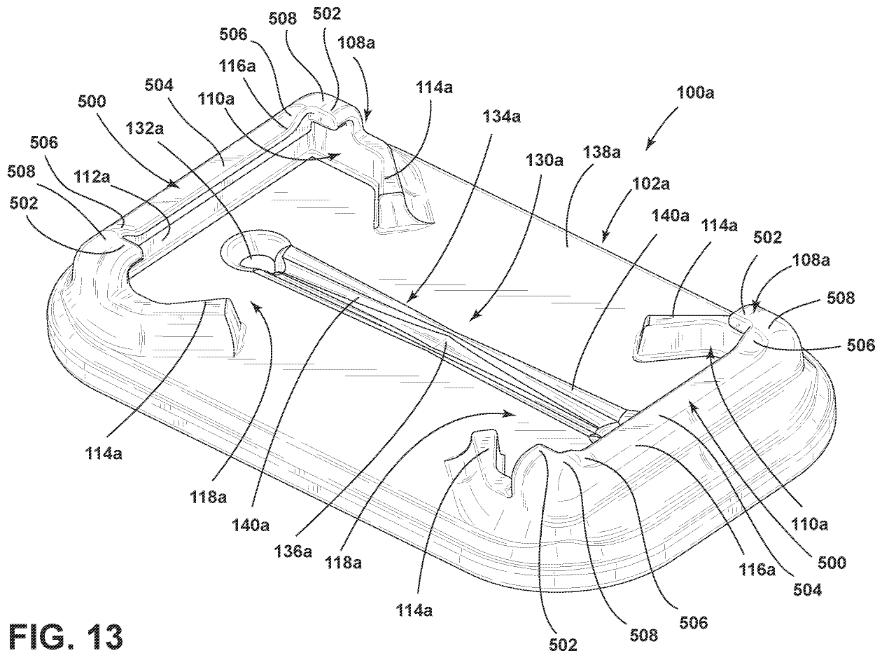

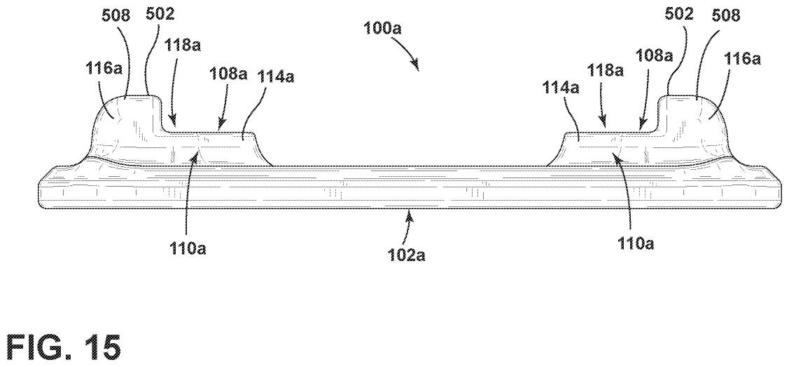

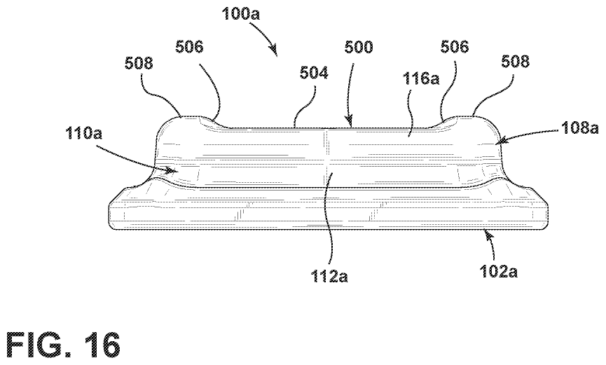

The reference numeral 100a (FIGS. 13-16) generally designates another embodiment of the present invention, having a second embodiment for the foot pad. Since foot pad 100a is similar to the previously described foot pad 100, similar parts appearing in FIGS. 4-8 and FIGS. 13-16, respectively, are represented by the same, corresponding reference number, except for the suffix “a” in the numerals of the latter. The second embodiment of the foot pad 100a is substantially identical to the first embodiment of the foot pad 100, except that the second embodiment of the foot pad 100a has a different top ledge 116a.

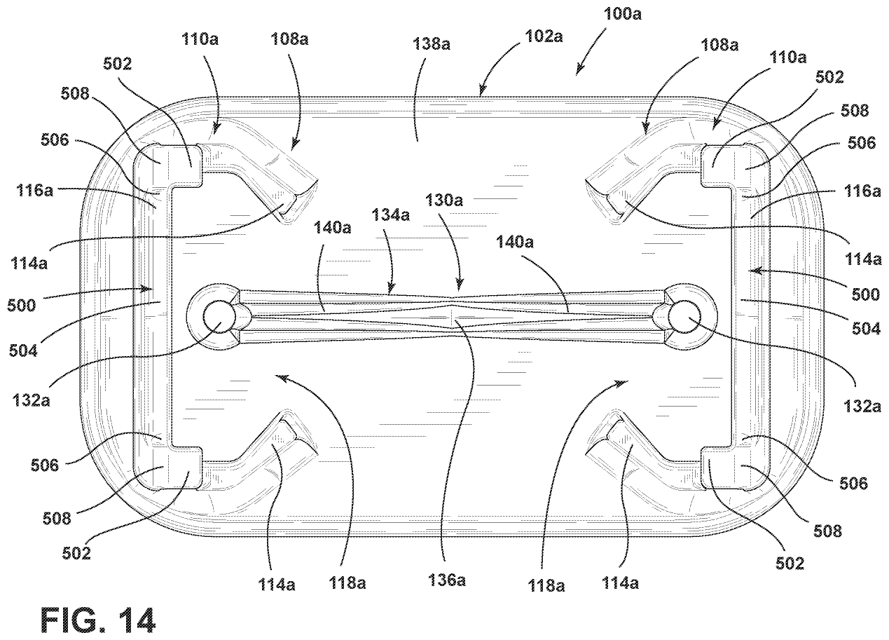

In the illustrated example, the second embodiment of the foot pad 100a securely receives the foot jack of the foot 24 of the prior art jack 16. The second embodiment of the foot pad 100a includes a top ledge 116a that is substantially C-shaped when viewed from above as shown in FIG. 14. The top ledge 116a includes a center ledge portion 500 connected to a top of the straight wall portion 112a of the C-shaped wall 110a and a pair of opposite end ledge portions 502 connected to a top of the curved wall portions 114a at an intersection of the straight wall portion 112a and each of the curved wall portions 114a. The center ledge portion 500 includes a lower middle area 504 that ramps at ramp areas 506 up to upper end areas 508 that are interconnected to the pair of opposite end ledge portions 502. The ramp areas 506 of the center ledge portion 500 are flexible to allow for the foot 24 of various jacks 16 that have opposite curved end wall areas 40 of different heights to securely be retained in the opposite facing receptacles 108a.

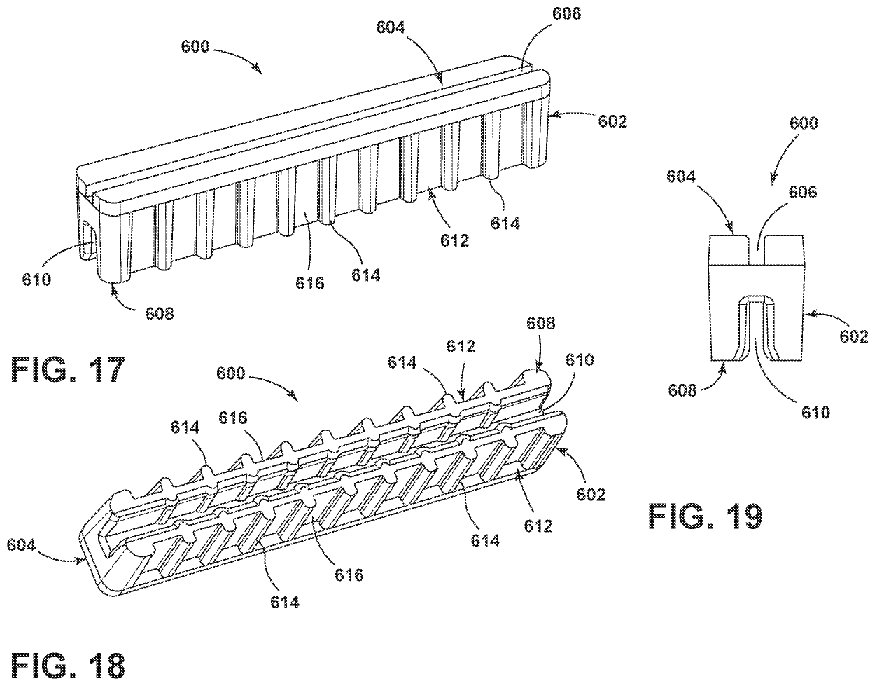

FIGS. 17-19 illustrate a filler piece 600 of the present invention. The filler piece 600 can be used to securely fit the foot 24 of the prior art into the foot pad 100, 100a of the present invention. If the foot 24 of the prior art jack does not fit securely into the foot pad 100, 100a, one or two filler pieces 600 can be connected to the foot 24 to enlarge the dimensions of the foot 24.

The illustrated filler piece 600 is configured to receive the wider end area 32 of the hourglass-shaped bottom plate 30 of the prior art foot 24 therein. The filler piece 600 comprises a longitudinal body 602 having a first face 604 and an opposite second face 606. The first face 604 includes a shallow slot 608 therein and the second face 606 includes a deep slot 610 therein. Side faces 612 of the filler piece 600 can include ribs 614 within a channel 616, with the channel 616 reducing the amount of material needed to form the filler piece 600 and the ribs 614 reinforcing the filler piece 600.

During use of the filler piece 600, the wider end area 32 of the hourglass-shaped bottom plate 30 of the prior art foot 24 is received within the shallow slot 608 or within the deep slot 610. If the wider end area 32 of the hourglass-shaped bottom plate 30 of the prior art foot 24 is positioned within the deep slot 610, the dimensions of the foot 24 are increased to a first amount. If the wider end area 32 of the hourglass-shaped bottom plate 30 of the prior art foot 24 is positioned within the shallow slot 608, the dimensions of the foot 24 are increased to a second amount larger than the first amount.

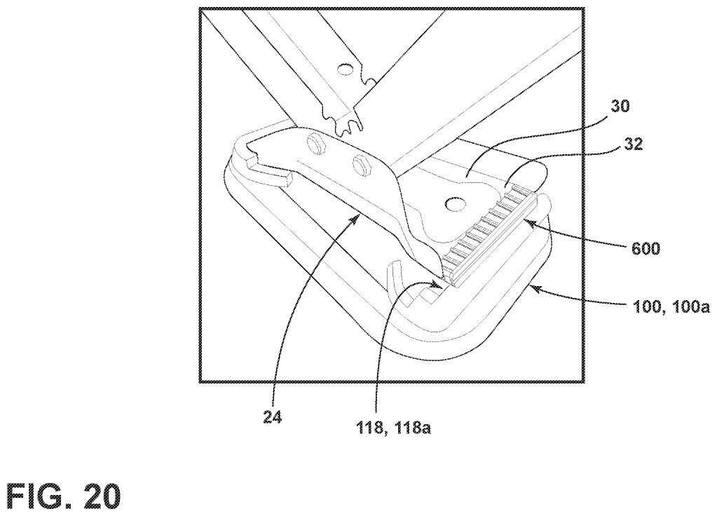

FIG. 20 illustrates a use of the filler piece 600 to enlarge the dimensions of the foot 24. As shown in FIG. 20, the wider end area 32 of the hourglass-shaped bottom plate 30 of the prior art foot 24 is received within the deep slot 610 of the filler piece 600. The filler piece 600 will therefore securely fit within the foot receptacle area 118, 118a of the foot pad 100, 100a. If the prior art foot 24 is smaller than that shown in FIG. 20, the filler piece 600 is flipped and the wider end area 32 of the hourglass-shaped bottom plate 30 of the prior art foot 24 is received within the shallow slot 608 of the filler piece 600. It is contemplated that a filler piece 600 could be used on each end of the hourglass-shaped bottom plate 30 of the prior art foot 24, using either the shallow slot 608 or the deep slot 610, to ensure the best fit of the foot 24 within the foot pad 100, 100a.

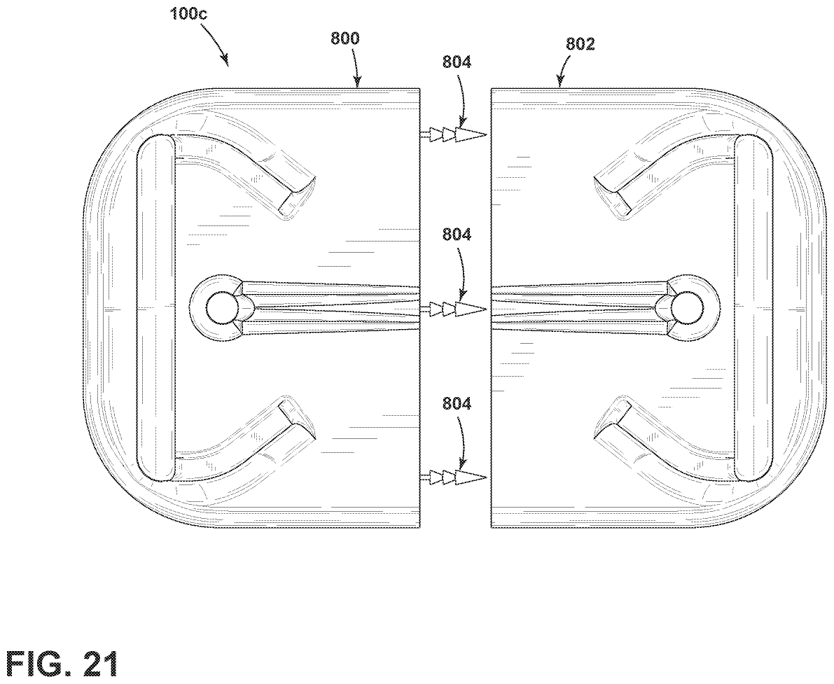

The reference numeral 100c (FIG. 21) generally designates another embodiment of the present invention, having a third embodiment for the foot pad. The third embodiment of the foot pad 100c can be substantially identical to the previously described foot pads 100, 100a, except that the foot pad 100c is split into 2 parts first, a first part 800 and a second part 802. The first part 800 includes prongs 804 configured to be received within corresponding holes in the second part 802. The first part 800 and the second part 802 allow the third embodiment of the foot pad 100c to be positioned over the foot 24, with the prongs 804 being inserted into the corresponding holes to lock the third embodiment of the foot pad 100c over the foot 24. It is contemplated that any number and form of prongs 804 and corresponding holes can be used.

Although particular preferred embodiments of the invention have been disclosed in detail for illustrative purposes, it will be recognized that variations or modifications of the disclosed apparatus, including the rearrangement of parts, lie within the scope of the present invention.

What is claimed is:

1. A recreational vehicle comprising:
a movable body having at least one wheel for moving the recreational vehicle;
a vertically adjustable jack supporting the movable body on a surface, the jack having a jack foot including a bottom plate and a pair of vertically extending walls extending upwardly from the bottom plate; and
a foot pad releasably secured to the jack foot of the jack, the foot pad being formed of a resilient and flexible material;
the foot pad including a pair of opposite facing receptacles, opposite ends of the jack foot including ends of the bottom plate and ends of the pair of vertically extending walls being received within each of the pair of opposite facing receptacles, the foot pad including top ledges extending over each of the pair of opposite facing receptacles, the resilient and flexible material of the foot pad being configured to be deflected to allow the opposite ends of the jack foot to be positioned within the pair of opposite facing receptacles and the pair of opposite facing receptacles then resiliently returning to an original shape of the foot pad.

2. The recreational vehicle of claim 1, wherein:
each of the receptacles is defined by a base, one of a pair of C-shaped walls and one of a pair of the top ledges of the foot pad, with the one of the pair of the top ledges being connected to one of the pair of C-shaped walls.

3. The recreational vehicle of claim 2, wherein:
the one of the pair of the top ledges extends a set distance from the base.

4. The recreational vehicle of claim 2, wherein:
the one of the pair of the top ledges includes a center ledge portion and a pair of opposite end ledge portions, the center ledge portion including a lower middle area that ramps at ramp areas up to upper end areas, the ramp areas of the center ledge portion being flexible.

5. The recreational vehicle of claim 1, wherein:
a base of the foot pad includes a plurality of recesses in a bottom surface there.

6. The recreational vehicle of claim 1, wherein:
a base of the foot pad includes a drain channel in a top surface thereof leading to at least one drain hole extending through the base.

7. A jack assembly for a recreational vehicle, the jack assembly comprising:
a vertically adjustable jack supporting a movable body on a surface, the jack having a jack foot including a bottom plate and a pair of vertically extending walls extending upwardly from the bottom plate; and
a foot pad releasably secured to the jack foot of the jack, the foot pad being formed of a resilient and flexible material;
the foot pad including a pair of opposite facing receptacles, opposite ends of the jack foot including ends of the bottom plate and ends of the pair of vertically extending walls being received within each of the pair of opposite facing receptacles, the foot pad including top ledges extending over each of the pair of opposite facing receptacles, the resilient and flexible material of the foot pad being configured to be deflected to allow the opposite ends of the jack foot to be positioned within the pair of opposite facing receptacles and the pair of opposite facing receptacles then resiliently returning to an original shape of the foot pad.

8. The jack assembly of claim 7, wherein:
each of the receptacles is defined by a base, one of a pair of C-shaped walls and one of a pair of the top ledges of the foot pad, with the one of the pair of the top ledges being connected to one of the pair of C-shaped walls.

9. The jack assembly of claim 8, wherein:
the one of the pair of the top ledges extends a set distance from the base.

10. The jack assembly of claim 8, wherein:
the one of the pair of the top ledges includes a center ledge portion and a pair of opposite end ledge portions, the center ledge portion including a lower middle area that ramps at ramp areas up to upper end areas, the ramp areas of the center ledge portion being flexible.

11. The jack assembly of claim 7, wherein:
a base of the foot pad includes a plurality of recesses in a bottom surface there.

12. The jack assembly of claim 7, wherein:
a base of the foot pad includes a drain channel in a top surface thereof leading to at least one drain hole extending through the base.

13. A foot pad configured to be connected to a vertically adjustable jack configured to support the vertically adjustable jack on a surface, the vertically adjustable jack having a jack foot including a bottom plate and a pair of vertically extending walls extending upwardly from the bottom plate, the foot pad comprising:
a base; and
a pair of opposite facing receptacles;
each of the receptacles is defined by the base, one of a pair of C-shaped walls and one of a pair of top ledges of the foot pad, with the one of the pair of top ledges being connected to one of the pair of C-shaped walls;
wherein the foot pad is configured to receive opposite ends of the jack foot including ends of the bottom plate and ends of the pair of vertically extending walls within each of the pair of opposite facing receptacles, resilient and flexible material of the foot pad being configured to be deflected to allow the opposite ends of the jack foot to be positioned within the pair of opposite facing receptacles and the pair of opposite facing receptacles then resiliently returning to an original shape of the foot pad.

14. The foot pad of claim 13, wherein:
the top ledges extend a set distance from the base.

15. The foot pad of claim 13, wherein:
the top ledges each include a center ledge portion and a pair of opposite end ledge portions, the center ledge portion including a lower middle area that ramps at ramp areas up to upper end areas, the ramp areas of the center ledge portion being flexible.

16. The foot pad of claim 13, wherein:
the base includes a plurality of recesses in a bottom surface there.

17. The foot pad of claim 13, wherein:
the base includes a drain channel in a top surface thereof leading to at least one drain hole extending through the base.

18. A method of connecting a foot pad to a vertically adjustable jack supporting a movable body having at least one wheel for moving a recreational vehicle, the method comprising:
providing the vertically adjustable jack supporting the movable body on a surface, the jack having a jack foot including a bottom plate and a pair of vertically extending walls extending upwardly from the bottom plate;
releasably securing a foot pad to the jack foot of the jack, the foot pad being formed of a resilient and flexible material, the foot pad including a pair of opposite facing receptacles, opposite ends of the jack foot including ends of the bottom plate and ends of the pair of vertically extending walls being received within each of the pair of opposite facing receptacles, the foot pad including top ledges extending over each of the pair of opposite facing receptacles;
wherein the step of releasably securing includes deflecting the resilient and flexible material of the foot pad and inserting the opposite ends of the jack foot within the pair of opposite facing receptacles;
resiliently returning the pair of opposite facing receptacles to an original shape of the foot pad.

19. The method of claim 18, wherein:
the top ledges extend a set distance from a base of the foot pad.

20. The method of claim 18, wherein:
the top ledges each include a center ledge portion and a pair of opposite end ledge portions, the center ledge portion including a lower middle area that ramps at ramp areas up to upper end areas, the ramp areas of the center ledge portion being flexible.
